(19) United States
(12) Patent Application Publication
(10) Pub. No.: US 2013/0316767 A1
(43) Pub. Date: Nov. 28, 2013

(54) ELECTRONIC DISPLAY STRUCTURE

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/478,351

(22) Filed: May 23, 2012

(51) Int. Cl. H04W 88/02; G09G 3/30; G09G 5/00

(52) U.S. Cl. 455/566; 345/207; 345/76

(57) ABSTRACT

An electronic display structure is provided. The electronic display structure includes a display structure, a camera unit, and a control unit. The display structure including a window portion can be a display case or a display window, which defines an inner space to accommodate objects. The objects in the inner space can be viewed from the exterior of the display structure through the window portion. The camera unit produces images in a direction toward the exterior of the display structure. The control unit determines an indicating direction of a user through the images, determines the object(s) indicated by the user according to the indicating direction, and transmits object data of the indicated object(s) to a transparent display or a portable device.

### BACKGROUND

1. Technical Field

The present disclosure relates to an electronic display structure, and particularly to an electronic display structure providing information of items in a display window or a display case in a dynamic way.

2. Description of Related Art

The items displayed in a conventional display window or display case are usually described through a static way such as a label or a sign. However, restricted by the size and/or the form of the label or the sign, the descriptions on the label or the sign are usually quite brief, and often fail to satisfy consumers since the requirements of the consumers are usually diverse.

What is needed, therefore, is a display structure capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an electronic display structure of the present disclosure.

FIG. 2 is a schematic diagram of an embodiment of the display structure and the camera unit shown in FIG. 1.

FIG. 3 is a schematic diagram of determining the direction of a vision line through the control unit shown in FIG. 1.

FIG. 4 is a schematic diagram of displaying object information through the transparent display shown in FIG. 1.

### DETAILED DESCRIPTION

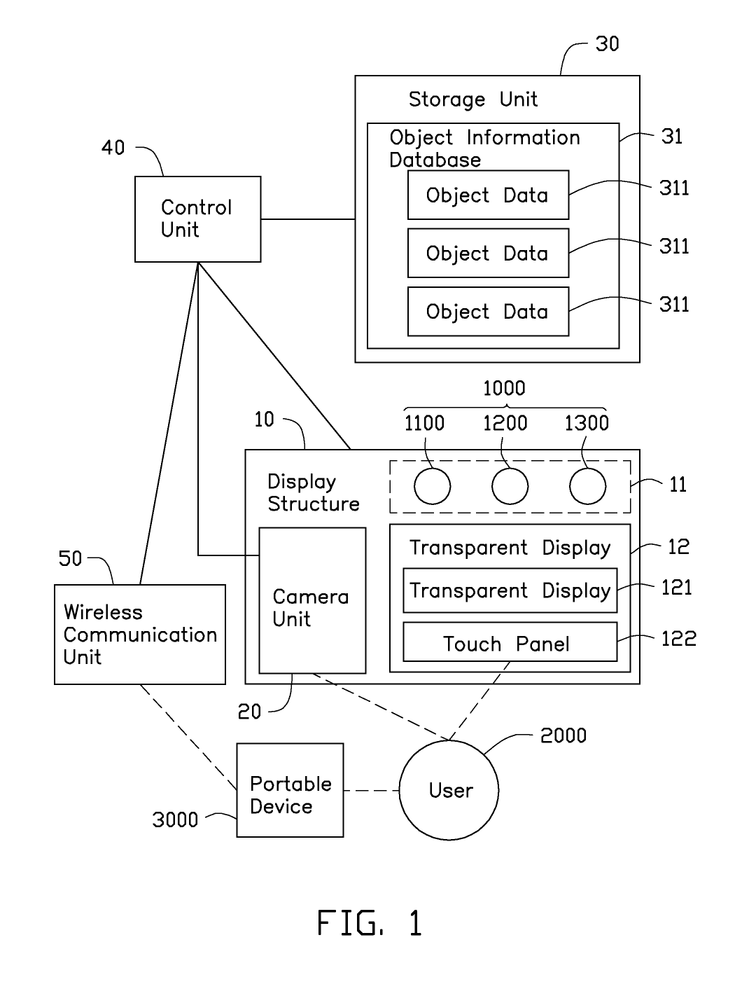

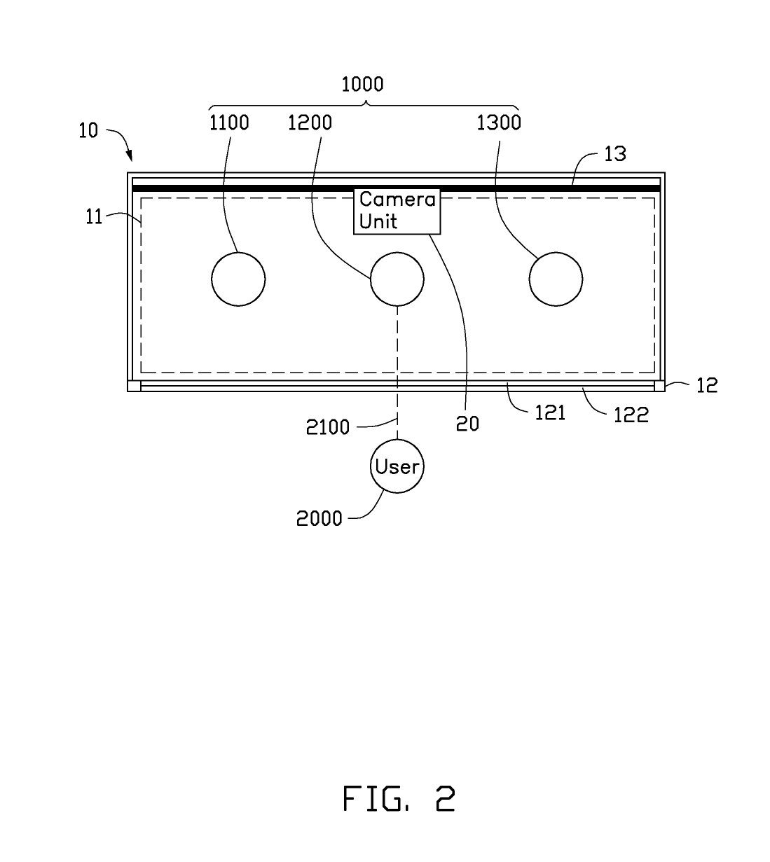

FIG. 1 is a block diagram of an embodiment of an electronic display structure of the present disclosure. The electronic display structure includes a display structure 10, a camera unit 20, a storage unit 30, a control unit 40, and a wireless communication unit 50. FIG. 2 is a schematic diagram of an embodiment of the display structure 10 and the camera unit 20 shown in FIG. 1. In the illustrated embodiment, the display structure 10 is a display window. In other embodiments, the display structure 10 can be another type of structure such as a display case. The display structure 10 defines an inner space 11 for accommodating display items 1000 such as items for sale. The display structure 10 includes a window portion 12, wherein the display items 1000 in the inner space 11 can be viewed from the exterior of the display structure 10 through the window portion 12. The window portion 12 includes a transparent display 121 and a touch panel 122. In the illustrated embodiment, the window portion 12 is disposed in a front side of the display structure 10, such that a user 2000 standing by the front side of the display structure 10 can view the display items 1000 in the inner space 11 through the window portion 12. The transparent display 121 is a transparent active-matrix organic light-emitting diode (AMOLED) display, wherein the display items 1000 can be viewed through the transparent display 121. The touch panel 122 produces touch position parameters Pt (not shown) in response to touch operations on the touch panel 122. In other embodiment, the window portion 12 can merely include a glass.

The camera unit 20 produces images in a direction toward the exterior of the display structure 10, such that the user 2000 standing before the window portion 12 can be photographed. The camera unit 20 may include a camera which is capable of producing the images such as still photographs or videos. In the illustrated embodiment, the camera unit 20 is disposed in the display structure 10 and at a position behind the window portion 12, such that the camera unit 20 can produce the images of any object in front of the display structure 10. The camera unit 20 is disposed on a rail 13 and automatically moved along the rail 13 to correspond to the position of the user 2000 with respect to the window portion 12, thereby keeping the portrait of the user 2000 to be at a central portion of the images. Consequently, the face of the user 2000 can be photographed when the user 2000 faces the window portion 12. In other embodiments, the camera unit 20 can be disposed at other positions, for example, a position in the exterior of the display structure 10 and in front of the window portion 12. In addition, a plurality of camera units 20 can be used to produce images in different directions toward the exterior of the display structure 10, thereby simultaneously photographing the user 2000 in different directions.

The storage unit 30 is a device such as a high speed random access memory, a non-volatile memory, or a hard disk drive for storing and retrieving digital information, which includes an object information database 31. The object information database 31 stores object data 311. Each of the object data 311 corresponds to each of the display items 1000, which includes information about the corresponding display item 1000, for example, the name, the type, and/or the description of the corresponding display item 1000. In addition, each of the object data 311 comprises a location information I1 (not shown) of the corresponding display item 1000. The location information I1 can be, for example, the relative position of the display item 1000 in the inner space 11.

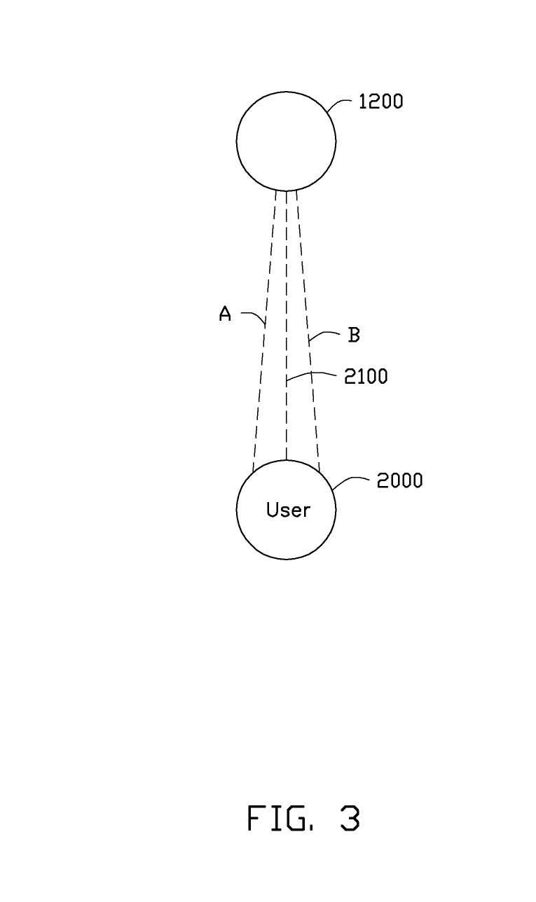

In the illustrated embodiment, the control unit 40 determines an indicating direction of the user 2000 according to the direction of a vision line of the user 2000 and the touch position parameters Pt received from the touch panel 122, wherein the indicating direction of the user 2000 is determined according to an image or a series of images produced by the camera unit 20. The control unit 40 determines an indicating direction of the user 2000 when receiving the touch position parameters Pt. In other embodiments, the control unit 40 can determine the indicating direction of the user 2000 according to the direction of a vision line of the user 2000. FIG. 3 is a schematic diagram of determining the direction of a vision line through the control unit 40 shown in FIG. 1. In the illustrated embodiment, the control unit 40 determines a first direction A and a second direction B of the eye balls of the user 2000 which are on the geometric centerline of the cornea of the eye balls of the user 2000, and determines a direction on the centerline between the first direction A and the second direction B as the direction of vision line 2100 of the user 2000. In other embodiments, the control unit 40 can determine the indicating direction of the user 2000 according to other characteristics of the user 2000, for example, indicating gestures of the user 2000 (accordingly, the indicating direction can be the direction of a forefinger of the user 2000). The control unit 40 then determines the display item(s) 1000 indicated by the user 2000 according to the indicating direction and the location information I1, for instance, the control unit 40, and transmits the object data 311 of the indicated display item 1000. The control unit 40 can determine the indicated display item(s) 1000 by, for instance, comparing the indicating direction with the location information I1.

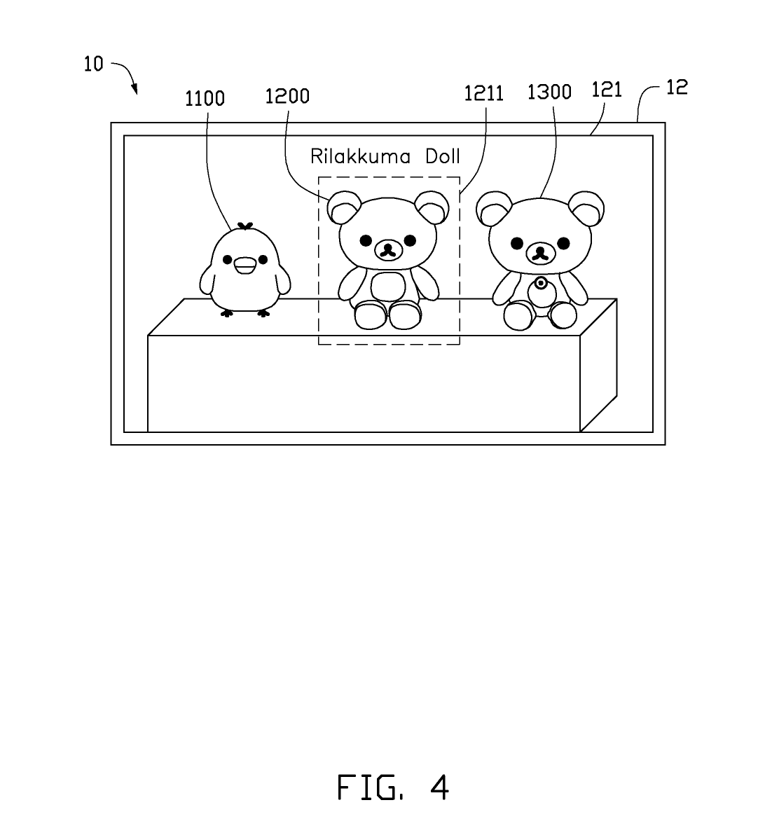

FIG. 4 is a schematic diagram of displaying object information 1211 through the transparent display 121 shown in FIG. 1. In the illustrated embodiment, the control unit 40 transmits the object data 311 of a display item 1200 indicated by the user 2000 to the transparent display 121. The transparent display 121 displays the object information 1211 according to the object data 311, wherein the object information 1211 includes the information of the display item 1200 such as the name, the type, and/or the description. The object information 1211 is displayed at position(s) of the transparent display 121 which corresponds to a virtual image of the display item 1200 projected on the transparent display 121 which is in the vision line 2100 of the user 2000, such that the user 2000 can see the information of the display item 120 in the vision line 2100. The display item 1200 can be marked by displaying an indication graph on the transparent display 121 to enclose the virtual image of the display item 1200 projected on the transparent display 121. In other embodiments, the control unit 40 can transmit the object data 311 to a portable device 3000 through the wireless communication unit 50, such that the information of the display item 120 can be viewed through the portable device 3000. The electronic display structure communicates with the portable device 3000 through a wireless network such as a BLUETOOTH network or a global system for mobile communications (GSM) network via the wireless communication unit 50.

The storage unit 30 can store stock information Is (not shown) of the display items 1000 in the inner space 11. Each of the stock information Is corresponds to a type of the display items 1000, for example, a series of items with different sizes which belong to a same type. In the illustrated embodiment, the control unit 40 receives personal parameters Pp (not shown) (for example, sex, age, and/or physical type) from the portable device 3000, produces available item information Ia (not shown) (for example, available sizes or colors of a same type of items) according to a comparison between the personal parameters Pp and the stock information Is corresponding to the display item 1000 indicated by the user 2000, and transmits the available item information Ia to the portable device 3000 (or the transparent display 121), such that available items corresponding to the display item 1000 indicated by the user 2000 can be viewed through the portable device 3000 (or the transparent display 121). In the illustrated embodiment, the portable device 3000 includes an application program which may automatically transmit the personal parameters Pp to the electronic display structure after receiving the object data 311 of the display item 1000 indicated by the user 2000.

In other embodiments, each of the display items 1000 can include a short distance wireless device. Correspondingly, the control unit 40 determines a location of the display items 1000 in the inner space 11 by communicating with the short distance wireless device on the display items 1000 through short distance wireless identifier(s). The short distance wireless identifier and the short distance wireless device can be, for example, a radio-frequency identification (RFID) reader and a RFID tag, respectively. In addition, the short distance wireless device on each of the display items 1000 can include the object data 311 of to the display item 1000. Correspondingly, the control unit 40 can receive the object data 311 of the display item 1000 from the short distance wireless device on the display item 1000 through the short distance wireless identifier.

The electronic display structure is capable of providing information of items in a display window or a display case in a dynamic way since the information can be created and edited through an electronic device such as computer. In addition, since the information of the items can be provided through the window portion of the display window or the display case, and the information of the items can be provided according to the requirements of individuals through using a portable device, the provision of the information is more intuitional and effective for users.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. An electronic display structure, comprising:
a display structure defining an inner space to accommodate one or more objects, wherein the display structure comprises a window portion, the one or more objects are viewed from the exterior of the display structure through the window portion;
a camera unit producing one or more images in one or more directions corresponding to the exterior of the display structure; and
a control unit, wherein the control unit determines an indicating direction of a user through the one or more images, determines the one or more objects indicated by the user according to the indicating direction, and transmits one or more object data corresponding to the one or more objects indicated by the user.

2. The electronic display structure of claim 1, wherein the display structure comprises at least one of a display window and a display case.

3. The electronic display structure of claim 1, wherein the control unit determines the indicating direction according to a direction of one or more eye balls of the user.

4. The electronic display structure of claim 3, wherein the control unit determines a first direction and a second direction of the eye balls of the user, and determines a direction on the centerline between the first direction and the second direction as the direction of vision line of the user.

5. The electronic display structure of claim 4, wherein the first direction and the second direction are on the geometric centerline of the cornea of the eye balls of the user.

6. The electronic display structure of claim 1, wherein the window portion comprises a touch panel producing one or more touch position parameters in response to a touch operation with respect to the touch panel, the control unit determines the indicating direction according to the one or more images and the one or more touch position parameters.

7. The electronic display structure of claim 6, wherein the control unit determines the direction of a vision line of the user, and determines the indicating direction according to the direction of the vision line of the user and the one or more touch position parameters.

8. The electronic display structure of claim 1, wherein the window portion comprises a transparent display, the one or more objects is viewed from the exterior of the display structure through the transparent display, the transparent display displays one or more object information at one or more positions of the transparent display according to the one or more object data; wherein the one or more positions of the transparent display corresponds to a virtual image of the one or more indicated objects projected on the transparent display in a vision line of the user.

9. The electronic display structure of claim 8, wherein the transparent display is a transparent active-matrix organic light-emitting diode (AMOLED) display.

10. The electronic display structure of claim 1, further comprising a wireless communication unit, the control unit transmits the one or more object data to a portable device through the wireless communication unit.

11. The electronic display structure of claim 1, wherein the storage unit stores the one or more object data.

12. The electronic display structure of claim 11, wherein each of the one or more object data comprises a location information of one of the one or more objects in the inner space, the control unit determines the one or more objects indicated by the user according to the indicating direction and the location information.

13. The electronic display structure of claim 1, further comprising one or more short distance wireless identifier, wherein the control unit determines a location of the one or more objects in the inner space by communicating with a short distance wireless device disposed on the one or more objects through the one or more short distance wireless identifier.

14. The electronic display structure of claim 1, further comprising one or more short distance wireless identifier, wherein the control unit receives the one or more object data from a short distance wireless device disposed on the one or more objects through the one or more short distance wireless identifier.

15. The electronic display structure of claim 1, further comprising a wireless communication unit communicating with a portable device, the storage unit stores one or more stock information corresponding to the one or more objects in the inner space, each of the one or more stock information corresponds to each type of the one or more objects, the control unit receives one or more personal parameters from the portable device, produces one or more available item information according to a comparison between the one or more personal parameters and the one or more stock information corresponding to the one or more objects indicated by the user, and transmits the one or more available item information to the portable device.
